(19) United States
(12) Patent Application Publication
(10) Pub. No.: US 2021/0056450 A1
(43) Pub. Date: Feb. 25, 2021

(54) SCHEDULING BASED ON PROBABILISTIC AVAILABILITY

(71) Applicant: International Business Machines Corporation, Armonk, NY (US)

(72) Inventors: Pasquale A. Catalano, Wallkill, NY (US); Prach Jerry CHUAYPRADIT, Apex, NC (US); SCHAYNE BELLROSE, Wappingers Falls, NY (US); Christopher John Hutton, Hurley, NY (US)

(21) Appl. No.: 16/543,716

(22) Filed: Aug. 19, 2019

(51) Int. Cl. G06N 7/00; G06Q 10/10

(52) U.S. Cl. CPC G06N 7/005; G06Q 10/1095

(57) ABSTRACT

Aspects of the present disclosure relate to event scheduling. An indication of an attempt to schedule a first meeting designated at a first time is received. Attendee calendar data for a prospective meeting attendee invited to the first meeting is received. A determination is made that the prospective meeting attendee is scheduled with a second meeting designated at the first time based on the attendee calendar data. A probabilistic availability that the prospective meeting attendee will be available to attend the first meeting at the first time is calculated. The probabilistic availability is then compared to a threshold. In response to the probabilistic availability satisfying the threshold, the first meeting at the first time is scheduled for the prospective meeting attendee.

### BACKGROUND

The present disclosure relates to scheduling, and in particular, to scheduling based on probabilistic availability.

Electronic scheduling tools enable users to plan out time slots at which events are intended to take place. This can aid users in ensuring they do not schedule a future event during an occupied time slot. Further, scheduling tools can enable facilitation of event scheduling between multiple users simultaneously. For example, a meeting host may have access to calendar views for a plurality of users and, using the calendar views for the plurality of users, the meeting host can select the appropriate time for the plurality of users based on their collective availability.

### SUMMARY

Aspects of the present disclosure relate to a computer-implemented method, system, and computer program product for event scheduling. An indication of an attempt to schedule a first meeting designated at a first time can be received. Attendee calendar data for a prospective meeting attendee invited to the first meeting can be received. A determination can be made that the prospective meeting attendee is scheduled with a second meeting designated at the first time based on the attendee calendar data. A probabilistic availability that the prospective meeting attendee will be available to attend the first meeting at the first time can be calculated. The probabilistic availability can then be compared to a threshold. In response to the probabilistic availability satisfying the threshold, the first meeting at the first time can be scheduled for the prospective meeting attendee.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram illustrating a computing environment in which illustrative embodiments of the present disclosure can be implemented.

FIG. 2 is a block diagram illustrating a computing environment in which illustrative embodiments of the present disclosure can be implemented.

FIG. 3 is a flow diagram illustrating an example method for updating meeting attendance history, in accordance with embodiments of the present disclosure.

FIG. 4 is a flow diagram illustrating an example method for facilitating the scheduling of meetings based on probabilistic availability, in accordance with embodiments of the present disclosure.

FIG. 5 is a calendar view of a schedule indicating meeting attendance history for different meetings, in accordance with embodiments of the present disclosure.

FIG. 6 is a calendar view of a schedule indicating probabilistic availability based on the meeting attendance histories depicted in FIG. 5, in accordance with embodiments of the present disclosure.

FIG. 7 is a high-level block diagram illustrating an example computer system that may be used in implementing one or more of the methods, tools, and modules, and any related functions described herein, in accordance with embodiments of the present disclosure.

FIG. 8 is a diagram illustrating a cloud computing environment, in accordance with embodiments of the present disclosure.

FIG. 9 is a block diagram illustrating abstraction model layers, in accordance with embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward scheduling, and in particular, to scheduling based on probabilistic availability. While the present disclosure is not necessarily limited to such applications, various aspects of the present disclosure may be appreciated through a discussion of various examples using this context.

Attempting to coordinate meetings between multiple users can be a challenging task. Often times, a meeting host (e.g., an individual scheduling a meeting between one or more attendees) picks a date and time that may not be optimal due to the meeting host attempting to reconcile conflicts based on the binary conditions “available” and “not available” for potential attendees. This can prevent the host from picking a meeting slot which may otherwise be suitable for all guests, based on conflicting meetings scheduled for multiple prospective attendees. For example, certain users may frequently book their calendars with meetings/events they often do not attend. It would be greatly beneficial to be able to determine probabilistic availability for prospective meeting attendees and use the probabilistic availability to facilitate the scheduling of meetings between hosts and attendees.

Aspects of the present disclosure relate to event scheduling based on probabilistic availability. An indication of an attempt to schedule a first meeting designated at a first time can be received. Attendee calendar data for a prospective meeting attendee invited to the meeting can be received. A determination can be made that the prospective meeting attendee is scheduled with a second meeting designated at the first time based on the attendee calendar data. A probabilistic availability that the prospective meeting attendee will be available to attend the first meeting at the first time can be calculated based on a meeting attendance history associated with the second meeting. In embodiments, the meeting attendance history can be calculated based on criteria associated with the second meeting (e.g., a meeting name, a time slot, an attendee list, etc.). The probabilistic availability is then compared to a threshold. In response to the probabilistic availability satisfying the threshold, the first meeting at the first time is scheduled for the prospective meeting attendee.

Aspects of the present disclosure enable the flexible scheduling of meetings between hosts and attendees, expanding on previous binary conditions “available” and “not available.” For example, if a particular prospective attendee books his calendar with a meeting every week that he never attends, aspects of the present disclosure can be configured to invite this attendee regardless of their calendar status displaying that their scheduled is booked. Further, only attendees which are likely (e.g., based on a predetermined threshold) to be available to attend the meeting will be invited.

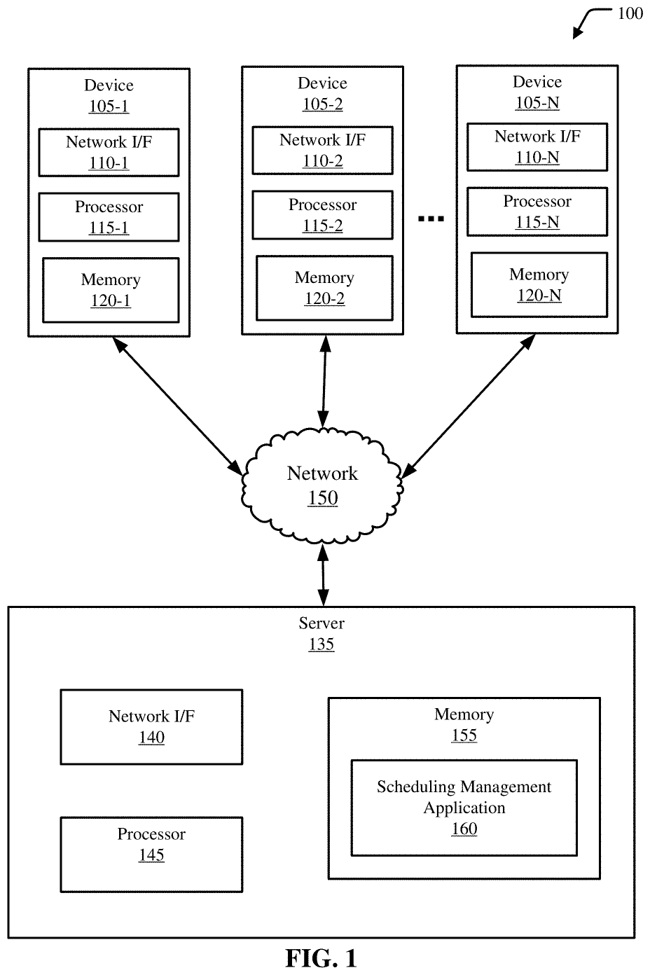

Turning now to the figures, FIG. 1 is a block diagram illustrating an example computing environment 100 in which illustrative embodiments of the present disclosure can be implemented. Computing environment 100 includes a plurality of devices 105-1, 105-2 . . . 105-N (collectively devices 105), at least one server 135, and a network 150.

Consistent with various embodiments, the server 135 and the devices 105 are computer systems. The devices 105 and the server 135 include one or more processors 115-1, 115-2 . . . 115-N (collectively processors 115) and 145 and one or more memories 120-1, 120-2 . . . 120-N (collectively memories 120) and 155, respectively. The devices 105 and the server 135 can be configured to communicate with each other through internal or external network interfaces 110-1, 110-2 . . . 110-N (collectively network interfaces 110) and 140. The network interfaces 110 and 140 are, in some embodiments, modems or network interface cards. The devices 105 and/or the server 135 can be equipped with a display or monitor. Additionally, the devices 105 and/or the server 135 can include optional input devices (e.g., a keyboard, mouse, scanner, video camera, or other input device), and/or any commercially available or custom software (e.g., browser software, communications software, server software, natural language processing software, search engine and/or web crawling software, scheduling software, etc.). The devices 105 and/or the server 135 can be servers, desktops, laptops, or hand-held devices.

The devices 105 and the server 135 can be distant from each other and communicate over a network 150. In some embodiments, the server 135 can be a central hub from which devices 105 can establish a communication connection, such as in a client-server networking model. Alternatively, the server 135 and devices 105 can be configured in any other suitable networking relationship (e.g., in a peer-to-peer (P2P) configuration or using any other network topology).

In some embodiments, the network 150 can be implemented using any number of any suitable communications media. For example, the network 150 can be a wide area network (WAN), a local area network (LAN), an internet, or an intranet. In certain embodiments, the devices 105 and the server 135 can be local to each other and communicate via any appropriate local communication medium. For example, the devices 105 and the server 135 can communicate using a local area network (LAN), one or more hardwire connections, a wireless link or router, or an intranet. In some embodiments, the devices 105 and the server 135 can be communicatively coupled using a combination of one or more networks and/or one or more local connections. For example, the first device 105-1 can be hardwired to the server 135 (e.g., connected with an Ethernet cable) while the second device 105-2 can communicate with the server 135 using the network 150 (e.g., over the Internet).

In some embodiments, the network 150 is implemented within a cloud computing environment, or using one or more cloud computing services. Consistent with various embodiments, a cloud computing environment can include a network-based, distributed data processing system that provides one or more cloud computing services. Further, a cloud computing environment can include many computers (e.g., hundreds or thousands of computers or more) disposed within one or more data centers and configured to share resources over the network 150.

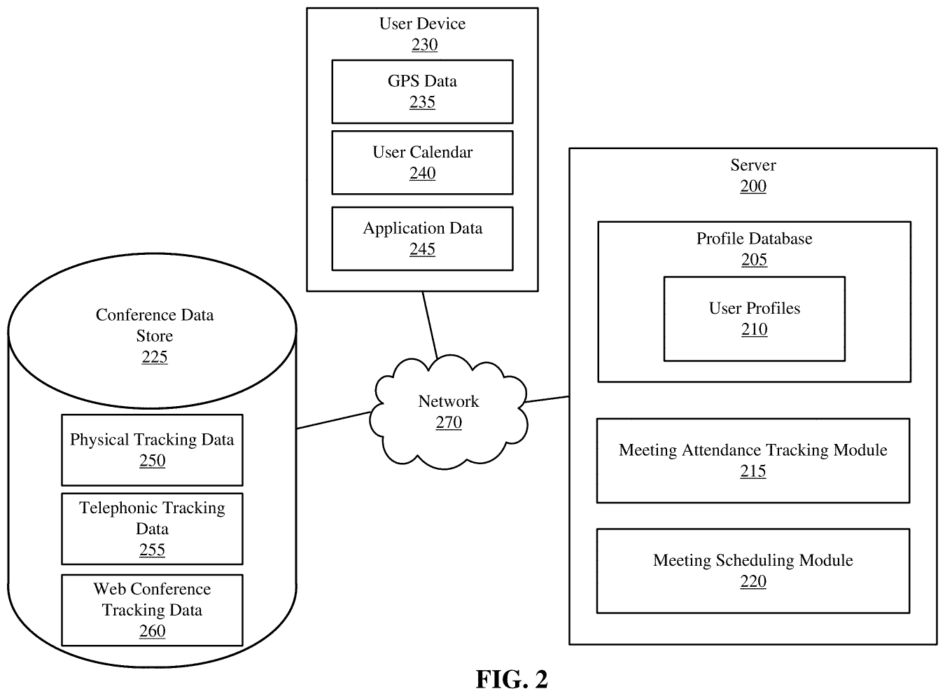

The server 135 includes a scheduling management application 160. The scheduling management application 160 can be configured to facilitate the scheduling of meetings between meeting hosts and prospective attendees. The scheduling management application 160 can access calendar data including meeting schedules for prospective attendees. The scheduling management application 160 can further be configured to determine meeting attendance history for past meetings based on data collected from various data sources (e.g., further described with respect to the conference data store 225 of FIG. 2).

Upon receiving an indication of a new meeting being scheduled, the scheduling management application 160 can check for conflicts noted in prospective attendee calendars. The scheduling management application 160 can be configured to transmit meeting invites to attendees without scheduling conflicts. For prospective attendees with scheduling conflicts, the scheduling management application can be configured to determine probabilistic availabilities that the prospective attendees will be able to attend the newly scheduled meeting based on their meeting attendance history. The probabilistic availabilities can be compared to a threshold to determine whether to transmit invites to prospective attendees with conflicting schedules. If the probabilistic availability satisfies a threshold for a given prospective attendee, the scheduling management application 160 can be configured to transmit a meeting invite to that prospective attendee.

Though this disclosure pertains to the collection of personal data (e.g., calendar data), in embodiments, users opt-in to the system (e.g., the scheduling management application 160). In doing so, they may, for example, be informed of what data is collected and how it will be used, that any collected personal data may be encrypted while being used, that users can opt-out at any time, and that if they opt-out, any personal data of the user is deleted.

FIG. 1 is intended to depict the representative major components of an example computing environment 100. In some embodiments, however, individual components can have greater or lesser complexity than as represented in FIG. 1, components other than or in addition to those shown in FIG. 1 can be present, and the number, type, and configuration of such components can vary.

While FIG. 1 illustrates a computing environment 100 with a single server 135, suitable computing environments for implementing embodiments of this disclosure can include any number of servers. The various models, modules, systems, and components illustrated in FIG. 1 can exist, if at all, across a plurality of servers and devices. For example, some embodiments can include two servers. The two servers can be communicatively coupled using any suitable communications connection (e.g., using a WAN, a LAN, a wired connection, an intranet, or the Internet).

Referring now to FIG. 2, illustrated is a block diagram of an example computing environment according to aspects of the present disclosure. The computing environment can include numerous components communicatively coupled by a network 270 such as, but not limited to, a server 200 (e.g., server 135 of FIG. 1), a conference data store 225, and a user device 230 (e.g., device 105-1 of FIG. 1).

The server 200 is configured to manage the scheduling of meetings between meeting hosts and prospective attendees. The server 200 includes a profile database 205, a meeting attendance tracking module 215, and a meeting scheduling module 220. The meeting attendance tracking module 215 can be configured to track meeting attendance and calculate probabilistic availability for users. The meeting scheduling module 220 can be configured to facilitate the scheduling of meetings based on, for example, probabilistic availabilities. In embodiments, the meeting attendance tracking module 215 and meeting scheduling module 220 can be processor executable instructions that can be executed by a dedicated or shared processor using received inputs.

In embodiments, the profile database 205 includes schedules for users, each stored in respective user profiles 210 within the profile database 205. For example, a user profile 210 within the profile database 205 can include a user calendar 240 received from user device 230. In embodiments, multiple schedules for each user can be merged into a single calendar. For example, a calendar from an application can be collected from application data 245 and can be merged and/or synchronized with a user calendar 240 stored on the user device 230. As an example, a calendar from a medical application specifying upcoming appointment times can be retrieved from application data 245 and merged with a user's generic calendar (e.g., user calendar 240) stored on the user device 230.

The user profiles 210 can also include meeting attendance histories. The meeting attendance histories can be calculated by the meeting attendance tracking module 215. The meeting attendance tracking module 215 can be configured to continually update meeting attendance histories over time. In some embodiments, the user profile 210 can also include the user's office phone number, web conference ID, or any other data that can be used by the meeting attendance tracking module 215.

The meeting attendance tracking module 215 can be configured to ascertain whether users attended meetings indicated within their user profile 210. This can be completed such that meeting attendance histories can be updated. The meeting attendance histories can be used to calculate probabilistic availability for upcoming meetings. Meeting attendance history can be calculated as number of times meeting was attended/total number of times meeting was scheduled. As an example, if a user attended a particular meeting 4/10 times, the meeting attendance history calculated by the meeting attendance tracking module 215 would be 40%. Probabilistic availability is calculated as 100%−meeting attendance history. As such, following the example above, the probabilistic availability that user would attend the newly scheduled meeting based on their meeting attendance history would be 100%-40%=60%.

In embodiments, the meeting attendance tracking module 215 references the conference data store 225 to determine whether a user attended a meeting. The conference data store 225 can include data indicating previous meeting attendance history. Such data includes physical tracking data 250, telephonic tracking data 255, and web conference tracking data 260.

Physical tracking data 250 can include sensor data collected from sensors associated with locations where meetings/events take place. Examples of physical tracking data include global positioning system (GPS) data, such as GPS data 235 collected from user device 230, badge reader data (e.g., data indicating whether a user scanned in to a conference room for a meeting), and internet of things (IoT) sensor data (e.g., camera data, fingerprint data, vehicular sensor data, smart chair data, wearable data, etc.). The physical tracking data 250 can be analyzed by the meeting attendance tracking module 215 to ascertain whether a user attended an elapsed meeting. For example, if a badge reader data indicates that the user scanned into a conference room associated with an elapsed meeting, then the meeting attendance tracking module 215 can be configured to determine that the user attended the elapsed meeting. The meeting attendance history can then be updated based on the determination that the user attended the recently elapsed meeting.

Telephonic tracking data 255 can include data associated with telephonic meetings, such as teleconference meeting identifiers (e.g., meeting numbers), telephone numbers that called into meetings (an attendee phone number list), and participants associated with teleconferences. The meeting attendance tracking module 215 can analyze the telephonic tracking data 255 to determine whether a user attended a telephonic meeting/event. For example, the meeting attendance tracking module 215 can analyze the telephonic tracking data 255 to ascertain that a phone number associated with a user's office phone called into a teleconference corresponding to a scheduled meeting. In this example, the meeting attendance tracking module 215 would determine that the user attended the meeting based on their office phone number being associated with the meeting within the telephonic tracking data 255.

Web conference tracking data 260 can include data associated with web-based conference meetings, such as user login activity, web-based room attendance, internet protocol (IP) identifiers that accessed a web-based meeting, etc. The meeting attendance tracking module 215 can analyze web conference tracking data 260 to ascertain whether a user attended a web-based meeting/event. For example, the meeting attendance tracking module 260 can determine that a particular user attended a meeting based on the user being logged into a web-conference during a time period corresponding to the meeting.

The meeting attendance tracking module 215 can calculate meeting attendance history based on various criteria associated with meetings. In some embodiments, the meeting attendance tracking module 215 calculates meeting attendance history based on time slots. For example, if a prospective attendee only attended 15/60 12:00 PM to 1:00 PM meetings in the past, then the meeting attendance history for the 12:00 PM to 1:00 PM time slot would be 25%. Following the example above, if the attendee is invited to a meeting which conflicts with an existing meeting scheduled between 12:00 PM to 1:00 PM, the probabilistic availability that the user can attend the new meeting is 75% (because the attendee only attended 25% of 12:00 PM to 1:00 PM meetings in the past). This can be completed for any suitable time span (e.g., 15 minutes, 30 minutes, 1 hour, 4 hour) and any suitable time slot.

In some embodiments, the meeting attendance tracking module 215 can calculate meeting attendance history based on meeting duration. For example, if a prospective attendee attended 0/3 four-hour meetings in the past, then the meeting attendance history for four-hour meetings would be 0%. Following the example above, if the attendee is invited to a meeting which conflicts with an existing four-hour meeting, the probabilistic availability that the user can attend the new meeting is 100% (because the attendee hasn't attended four-hour meetings in the past). This can be completed for any suitable meeting duration.

In some embodiments, the meeting attendance tracking module 215 can calculate meeting attendance history based on time of year, such as during particular seasons, months, holidays, etc. For example, if a prospective attendee attended 1/20 meetings during the last two weeks of December in the past, then the meeting attendance history for meetings scheduled during the last two weeks of December would be 5%. Following the example above, if the attendee is invited to a meeting which conflicts with an existing meeting scheduled during the last two weeks of December, the probabilistic availability that the user can attend the new meeting is 95% (because the attendee has only attended 5% of meetings scheduled during the last two weeks of December in the past). This can be completed for any suitable time period.

In some embodiments, the meeting attendance tracking module 215 can calculate meeting attendance history based on meeting name. For example, if a prospective attendee attended 99/100 meetings labeled “Inventor Interview” in the past, then the meeting attendance history for meetings labeled “Inventor Interview” would be 99%. Following the example above, if the attendee is invited to a meeting which conflicts with an existing meeting named “Inventor Interview”, the probabilistic availability that the user can attend the new meeting is 1% (because the attendee has attended 99% of meetings with the name “Inventor Interview” in the past). This can be completed for any suitable meeting name. In some embodiments, phrases, words, characters, numbers, etc. of meeting names can be considered rather than full names. For example, meeting attendance history can be calculated for any meeting containing the word “Inventor.” As such, meeting attendance history could be collectively calculated for meetings labeled, “Inventor Interview,” “Inventor Mining Session,” “Inventor Disclosure Discussion,” “Meeting with Inventors,” etc.

In some embodiments, the meeting attendance tracking module 215 can calculate meeting attendance history based on attendees. For example, if a prospective attendee attended 1/5 meetings that “John Smith” also attended in the past, then the meeting attendance history for meetings where “John Smith” is an attendee would be 20%. Following the example above, if the attendee is invited to a meeting which conflicts with an existing meeting where “John Smith” is also an attendee, the probabilistic availability that the user can attend the new meeting is 80% (because the attendee only attended 20% of meetings where “John Smith” was also an attendee in the past). This can be completed for any suitable number of attendees, including attendee lists (e.g., a board of directors, a group of inventors, a group of employees, etc.). In another embodiment, the meeting attendance tracking module 215 can calculate meeting attendance history based on meeting host.

In embodiments, multiple criteria can be simultaneously considered when calculating meeting attendance history. For example, the meeting attendance tracking module 215 can calculate meeting attendance history based on a time slot, a meeting name, and an attendee list. As an example, if an attendee attended 4/5 meetings occurring during a first time slot, having a first meeting name, and attended by a first attendee, then the meeting attendance tracking module 215 would calculate a meeting attendance history of 80% for meetings occurring during the first time slot, having the first meeting name, and attended by the first attendee. Following the example above, if the attendee is invited to a meeting which conflicts with an existing meeting scheduled during the first time slot, having the first meeting name, and having the first attendee, the probabilistic availability that the user can attend the new meeting is 20% (because the attendee attended 80% of meetings scheduled during the first time slot, having the first meeting name, and having the first attendee). Any suitable number and/or type of criteria can be considered when calculating meeting attendance history and/or probabilistic availability.

The meeting scheduling module 220 can be configured to utilize the meeting attendance history to determine whether to schedule meetings between hosts and attendees. The meeting scheduling module 220 can be configured to receive an indication of a meeting being scheduled by a host (scheduled at a particular time for a particular duration). The meeting scheduling module 220 can then be configured to determine an attendee list associated with the meeting. For example, the meeting scheduling module 220 can receive an attendee list specified by the host. The meeting scheduling module 220 can then be configured to receive calendar data and attendance data for each attendee from the meeting attendance tracking module 215. This is used such that the meeting scheduling module 220 can determine whether attendees are already scheduled during the time of the meeting and, if they are scheduled, the probability that the attendees will be available to attend the meeting based on meeting attendance history associated with any conflicting meetings.

The meeting scheduling module 220 then facilitates the transmission of invites to attendees based on the schedules/probabilistic availabilities. In embodiments, the meeting scheduling module 220 transmits invites to (or alternatively, directly schedules the meetings for) attendees who do not have conflicts during the meeting duration. That is, for any available attendees, the meeting scheduling module 220 transmits meeting invites specified by the host. In embodiments, if attendees are already scheduled during the time of the meeting, then the meeting scheduling module 220 can be configured to compare the probability that an attendee is available to attend the meeting to a threshold. If the probabilistic availability for a given attendee satisfies the threshold, then the meeting scheduling module 220 can be configured to transmit the invite specified by the host to the attendee. For example, assume a minimum probabilistic availability threshold required to transmit a meeting invite to a first attendee is 50%. If a probabilistic availability that the first attendee attends the meeting is 60%, then the meeting scheduling module 220 would transmit the meeting invite to the first attendee.

In some embodiments, the meeting scheduling module 220 can facilitate the canceling of meetings based on a portion of attendees that are unavailable (e.g., due to scheduling conflicts and/or probabilistic attendances not satisfying thresholds). For example, the meeting scheduling module can compare the number of available attendees (e.g., those without schedule conflicts or those with a probabilistic availability satisfying a threshold) to a threshold number of attendees required to schedule the meeting. If the number of available attendees falls below the threshold number of attendees required to schedule the meeting, the meeting scheduling module 220 can be configured to not transmit any meeting invites. In some embodiments, the meeting scheduling module 220 can transmit a notification to the host inquiring whether they still desire to schedule a meeting based on the prospective low attendance.

In embodiments, the meeting scheduling module 220 can be configured to transmit invites based on updates to probabilistic attendances for prospective attendees over time. For example, if, at a first time, a first prospective attendee has a probabilistic attendance which does not satisfy a threshold, the meeting scheduling module 220 can be configured to not transmit an invite to the first prospective attendee at the first time. However, if, at a second time, the probabilistic attendance for the first prospective attendee satisfies the threshold (e.g., due to updated meeting attendance history), the meeting scheduling module 220 can be configured to transmit an invite to the first prospective attendee at the second time.

Network 270 can comprise any physical or virtual network, including Wi Fi, broadband, cellular, short-range, and/or other networks. Although a single network is shown, multiple similar or dissimilar sub-networks may likewise be used to continuously or intermittently connect various components illustrated in FIG. 2. In some embodiments, components shown in FIG. 2 may communicate via ANT/ANT+, Bluetooth, cellular (e.g., 3G, 4G, 5G, etc.), infrared, 6LoWPAN, ultra-wideband (UWB), long range RFID, Wi Fi, wirelessHART, and/or WirelessHD protocols. Further, in embodiments, data can be encrypted (e.g., using one or more cryptographic hash functions) prior to transmission such that various communication mechanisms can be used without putting the data at risk.

FIG. 2 is intended to represent the major components of an example computing environment 200 according to embodiments of the present disclosure. In some embodiments, however, individual components can have greater or lesser complexity than shown in FIG. 2, and components other than, or in addition to those shown in FIG. 2 can be present. Furthermore, in some embodiments, various components illustrated in FIG. 2 can have greater, lesser, or different functionality than shown in FIG. 2. Further still, aspects of the present disclosure exist comprising only a subset of the components illustrated while remaining within the spirit and scope of the present disclosure.

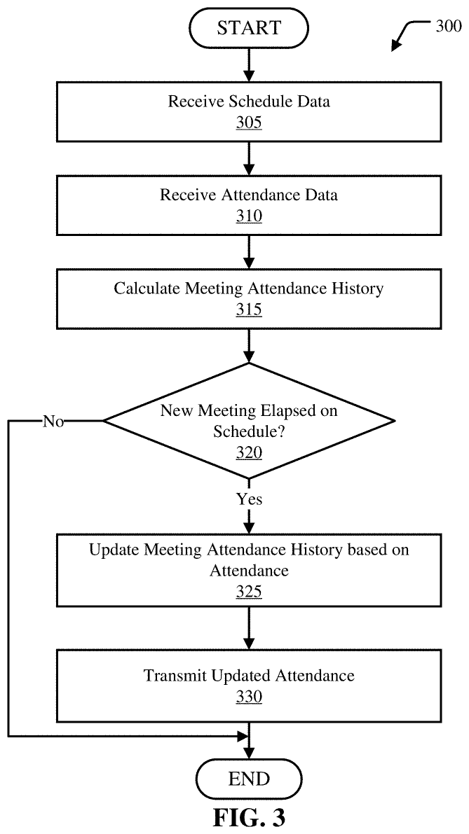

Referring now to FIG. 3, shown is a flow diagram illustrating an example method 300 for updating meeting attendance history for attendees, in accordance with embodiments of the present disclosure.

Method 300 initiates at operation 305, where schedule data is received. Schedule data can include calendars indicating currently scheduled meetings and/or meeting invites. In embodiments, multiple calendar sources can be received and combined, such as calendars from different applications. Overall, schedule data specifies the time slots in which applicable attendees are occupied, according to meetings already scheduled (e.g., accepted or prospectively planned) by the attendees.

Attendance data is then received. This is illustrated at operation 310. Attendance data can include data confirming whether attendees attended meetings. For example, attendance data can include data described with respect to the conference data store 225 of FIG. 2. For example, physical tracking data (e.g., received from badge readers, IoT sensors, etc.), telephonic tracking data (e.g., attendee lists associated with teleconferences), and web conference tracking data (e.g., user identifications (ID's) that logged into web conferences) can be analyzed to determine whether attendees attended meetings. In some embodiments, users can explicitly indicate their attendance for past meetings. This can occur in response to a prompt by the system or overtime by the user.

Meeting attendance history is then calculated. This is illustrated at operation 315. Meeting attendance history can be calculated based on any suitable criteria, including those described with respect to the meeting attendance tracking module 215. For example, attendance history can be calculated based on meeting name, time slot, meeting duration, attendee lists, etc. Attendance history can be calculated by dividing a number of confirmed attendances (e.g., based on attendance data received at operation 310) by a total number of times the meeting was scheduled (sharing a particular criterion).

A determination is then made whether a new meeting elapsed on a schedule. This is illustrated at operation 320. If no new meetings have elapsed on the schedule, then method 300 ends, as there are no new updates to account for. If a new meeting has elapsed on the schedule, then the meeting attendance history is updated based on attendance. This is illustrated at operation 325. For example, if a previous meeting attendance history was (X/Y)×100%, where X is a number of confirmed attendances and Y is a number of total times the meeting was scheduled, then, if the meeting was attended, the new meeting attendance history would be (X+1/Y+1)×100%. In contrast, if the meeting was not attended, the new meeting attendance history would be (X/Y+1)×100%.

The updated attendance can then be transmitted. This is illustrated at operation 330. For example, the updated attendance could be transmitted to a device, machine, user, or module (e.g., meeting scheduling module 220 of FIG. 2) responsible for facilitating the scheduling of meetings based on meeting attendance history.

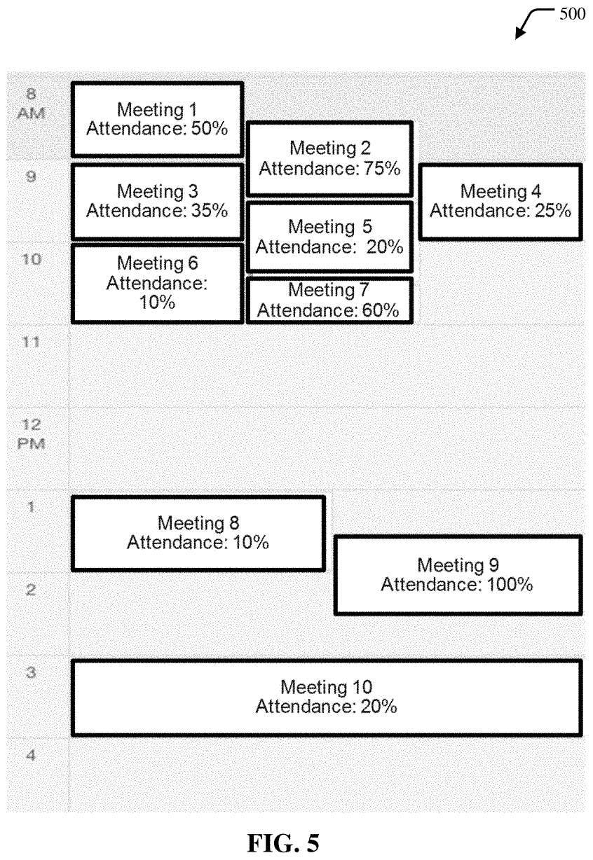

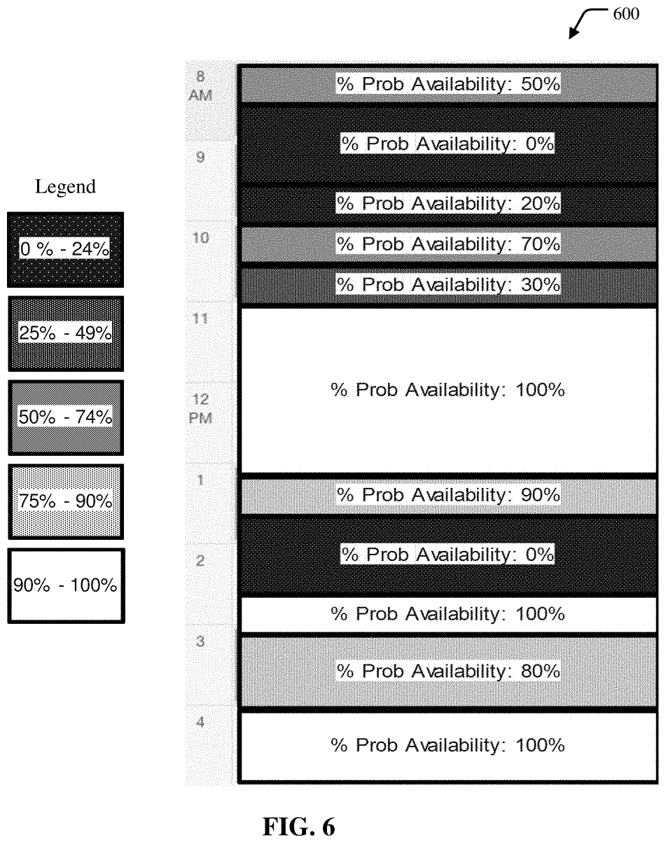

In embodiments, the meeting attendance history is used to calculate a probabilistic availability that a prospective attendee will be available to attend a newly schedule meeting. The probabilistic availability can be calculated as 100%−meeting attendance history. In some embodiments, the meeting attendance history for multiple meetings concurrently scheduled can be collectively considered when calculating a probabilistic availability. See for example, FIGS. 5-6. Probabilistic attendance based on multiple attendance histories for multiple concurrently scheduled meetings can be calculated as: 100%−meeting attendance history 1−meeting attendance history 2 . . . −meeting attendance history n, where the probabilistic attendance cannot be negative.

The aforementioned operations can be completed in any practical order and are not limited to those described. Additionally, some, all, or none of the aforementioned operations can be completed, while still remaining within the spirit and scope of the present disclosure.

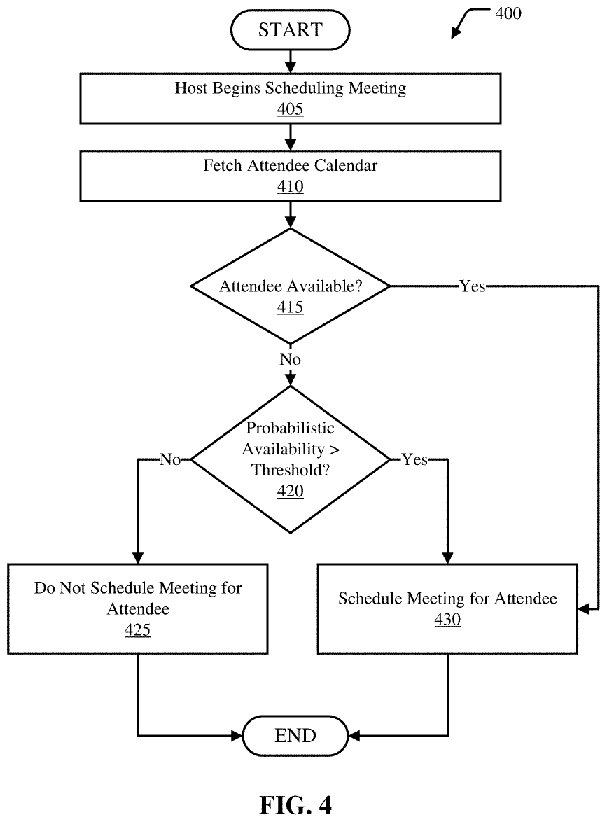

Referring now to FIG. 4, shown is a flow diagram illustrating an example method 400 for facilitating the scheduling of a meeting based on probabilistic availability, in accordance with embodiments of the present disclosure.

Method 400 initiates at operation 405, where a host begins scheduling a meeting. The host can begin scheduling the meeting by specifying an attendee list, a meeting location (e.g., a physical location, web conference link, teleconference line, etc.), a meeting name, a time slot, and a day of week.

An attendee calendar of an attendee that was indicated within the host's meeting schedule is then received. This is illustrated at operation 410. The attendee calendar can include the time slots the attendee has already scheduled (e.g., by accepting meeting invites, confirming meetings, etc.). The attendee calendar can be updated over time, based on meeting cancellations, reschedules, and newly scheduled meetings.

A determination is then made whether the attendee is available during the time slot indicated within the host meeting invite. This is illustrated at operation 415. If the attendee is available (e.g., there are no meetings scheduled within the attendee's calendar which occur during the host's meeting time slot), then the meeting is scheduled between the host and the attendee. This is illustrated at operation 430.

If the attendee is not available (e.g., there is a meeting scheduled within the attendee's calendar which conflicts with the host's meeting time slot), then a determination is made whether a probabilistic availability that the attendee attends the host's meeting satisfies a threshold. This is illustrated at operation 420. If the probabilistic availability that the attendee attends the host's meeting does not satisfy a threshold, then the meeting is not scheduled between the host and the attendee (e.g., the meeting invite is canceled). This is illustrated at operation 425. If the probabilistic attendance that the attendee attends the host's meeting does satisfy a threshold, then the meeting is scheduled between the host and the attendee at operation 430.

The aforementioned operations can be completed in any practical order and are not limited to those described. Additionally, some, all, or none of the aforementioned operations can be completed, while still remaining within the spirit and scope of the present disclosure.

Referring now to FIG. 5, illustrated is a calendar view of a schedule 500 having ten meetings with corresponding meeting attendance history percentages. As shown in FIG. 5, “Meeting 1” is scheduled between 8:00 AM and 9:00 AM with a 50% attendance history percentage, “Meeting 2” is scheduled between 8:30 AM and 9:30 AM with a 75% attendance history percentage, “Meeting 3” is scheduled between 9:00 AM and 10:00 AM with a 35% attendance history percentage, “Meeting 4” is scheduled between 9:00 AM and 10:00 AM with a 25% attendance history percentage, “Meeting 5” is scheduled between 9:30 AM and 10:30 AM with a 20% attendance history percentage, “Meeting 6” is scheduled between 10:00 AM and 11:00 AM with a 10% attendance history percentage, “Meeting 7” is scheduled between 10:30 AM and 11:00 AM with a 60% attendance history percentage, “Meeting 8” is scheduled between 1:00 PM and 2:00 PM with a 10% attendance history percentage, “Meeting 9” is scheduled between 1:30 PM and 2:30 PM with a 100% attendance history percentage, and “Meeting 10” is scheduled between 3:00 PM and 4:00 PM with a 20% attendance history percentage.

Consistent with embodiments, the meeting attendance histories can consider any suitable criteria, such as those described with respect to the attendance tracking module 215 of FIG. 2. For example, the attendance history for “Meeting 1” could be calculated based on a first meeting name, the attendance history for “Meeting 2” could be calculated based on a first attendee list, the attendance history for “Meeting 3” could be calculated based on a second meeting name, the attendance history for “Meeting 4” could be calculated based on a second attendee list, etc. The meeting attendance histories are calculated based on dividing a number of attended meetings by a total number of invites to similar meetings (meetings sharing a criterion, such as meetings having the same meeting name or having the same attendee list).

FIG. 6 is a diagram illustrating a calendar view of a schedule 600 depicting probabilistic availability at different time slots based on the meeting attendance histories depicted in FIG. 5. As shown in FIG. 6, the attendee associated with the schedule 600 has a 50% probabilistic availability from 8:00 AM-8:30 AM, a 0% probabilistic availability from 8:30 AM-9:30 AM, a 20% probabilistic availability from 9:30 AM-10:00 AM, a 70% probabilistic availability from 10:00 AM-10:30 AM, a 30% probabilistic availability from 10:30 AM-11:00 AM, a 100% probabilistic availability from 11:00 AM-1:00 PM, a 90% probabilistic availability from 1:00 PM-1:30 PM, a 0% probabilistic availability from 1:30 PM-2:30 PM, a 100% probabilistic availability from 2:30 PM-3:00 PM, an 80% probabilistic availability from 3:00 PM-4:00 PM, and a 100% probabilistic availability from 4:00 PM-5:00 PM.

The probabilistic availability can be calculated by 100%−meeting attendance 1−meeting attendance 2 . . . −meeting attendance n, where “n” is the total number of concurrently scheduled meetings during a particular time slot. As an example, the probabilistic availability of the attended from 10:30 AM-11:00 AM can be calculated as 100%−Meeting 6 attendance (10%)−Meeting 7 attendance (60%)=30%.

The calculated probabilistic attendance values can then be used to facilitate the scheduling of meetings based on a predetermined threshold. For example, if a 60% probabilistic availability threshold is required to transmit a meeting invite (or alternatively, automatically schedule a meeting) to this particular attendee, the meeting invite would only be transmitted if it was scheduled during the following time periods: 10:30 AM-11:00 AM (70%), 11:00 AM-1:00 PM (100%), 1:00 PM-1:30 PM (90%), 2:30 PM-3:00 PM (100%), 3:00 PM-4:00 PM (80%), and 4:00 PM-5:00 PM (100%). This is because the probabilistic availabilities during these time periods exceeds (satisfies) the threshold of 60%.

As shown in FIG. 6, the schedule 600 is textured (e.g., patterned) based on different probabilistic availability percentage ranges. In this example, the textures become darker as the probabilistic availability goes down. This can aid users in quickly ascertaining prospective time periods in which users may have higher probabilistic availability. For example, the 90-100% probabilistic availability range does not have a texture (indicating higher probabilistic availability), while the 0-24% probabilistic availability range has a dark texture (indicating lower probabilistic availability). However, the schedule 600 can be visually depicted in any suitable manner. For example, different colors, shades, contours, etc. can be applied to different probabilistic availability ranges such that users can readily ascertain probabilistic availabilities at different time periods, to aid in selecting scheduling times between multiple users.

The aforementioned operations can be completed in any order and are not limited to those described. Additionally, some, all, or none of the aforementioned operations can be completed, while still remaining within the spirit and scope of the present disclosure.

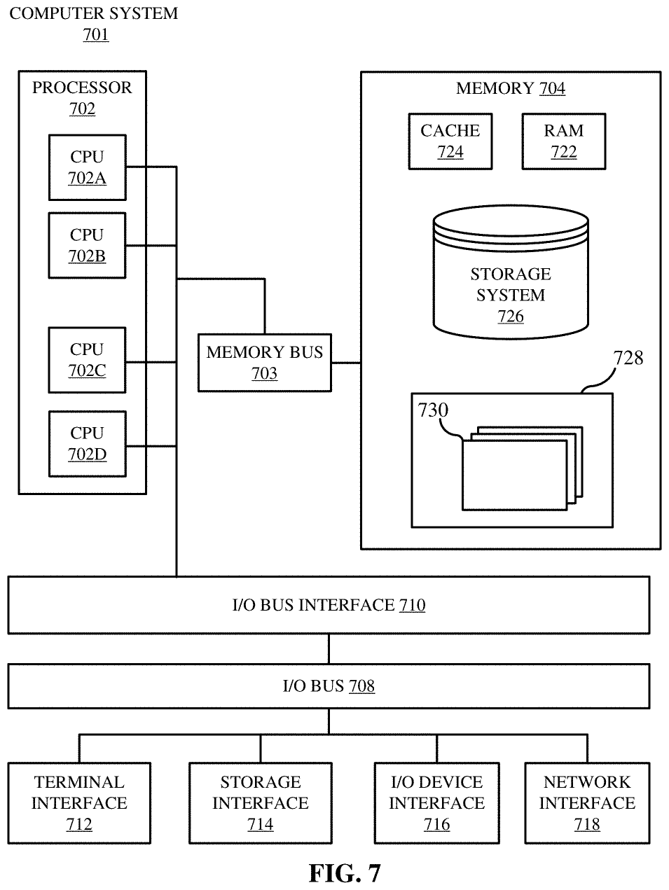

Referring now to FIG. 7, shown is a high-level block diagram of an example computer system 701 that may possibly be utilized in various devices discussed herein (e.g., devices 105, server 135, server 200, user device 230, etc.) and that may be used in implementing one or more of the methods, tools, and modules, and any related functions, described herein (e.g., using one or more processor circuits or computer processors of the computer), in accordance with embodiments of the present disclosure. In some embodiments, the major components of the computer system 701 may comprise one or more CPUs 702, a memory subsystem 704, a terminal interface 712, a storage interface 714, an I/O (Input/Output) device interface 716, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable central processing units (CPUs) 702A, 702B, 702C, and 702D, herein generically referred to as the CPU 702. In some embodiments, the computer system 701 may contain multiple processors typical of a relatively large system; however, in other embodiments the computer system 701 may alternatively be a single CPU system. Each CPU 702 may execute instructions stored in the memory subsystem 704 and may include one or more levels of on-board cache.

System memory 704 may include computer system readable media in the form of volatile memory, such as random access memory (RAM) 722 or cache memory 724. Computer system 701 may further include other removable/non-removable, volatile/non-volatile computer system storage media. By way of example only, storage system 726 can be provided for reading from and writing to a non-removable, non-volatile magnetic media, such as a “hard-drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 704 can include flash memory, e.g., a flash memory stick drive or a flash drive. Memory devices can be connected to memory bus 703 by one or more data media interfaces. The memory 704 may include at least one program product having a set (e.g., at least one) of program modules that are configured to carry out the functions of various embodiments.

One or more programs/utilities 728, each having at least one set of program modules 730 may be stored in memory 704. The programs/utilities 728 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 728 and/or program modules 730 generally perform the functions or methodologies of various embodiments.

In some embodiments, the program modules 730 of the computer system 701 may include a scheduling module. The scheduling module can be configured to receive an indication of an attempt to schedule a first meeting designated at a first time. The scheduling module can further be configured to receive attendee calendar data for a prospective meeting attendee invited to the first meeting. The scheduling module can further be configured to determine, by analyzing the attendee calendar data, that the prospective meeting attendee is scheduled with a second meeting designated the first time. The scheduling module can be configured to calculate a probabilistic availability that the prospective meeting attendee will be available to attend the first meeting at the first time. The scheduling module can then be configured to compare the probabilistic availability to a threshold. In response to the probabilistic availability satisfying the threshold, the scheduling module can be configured to schedule the first meeting at the first time for the prospective meeting attendee.

Although the memory bus 703 is shown in FIG. 7 as a single bus structure providing a direct communication path among the CPUs 702, the memory subsystem 704, and the I/O bus interface 710, the memory bus 703 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units are shown, which separate the I/O bus 708 from various communications paths running to the various I/O devices, in other embodiments some or all of the I/O devices may be connected directly to one or more system I/O buses.

In some embodiments, the computer system 701 may be a multi-user mainframe computer system, a single-user system, or a server computer or similar device that has little or no direct user interface, but receives requests from other computer systems (clients). Further, in some embodiments, the computer system 701 may be implemented as a desktop computer, portable computer, laptop or notebook computer, tablet computer, pocket computer, telephone, smart phone, network switches or routers, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

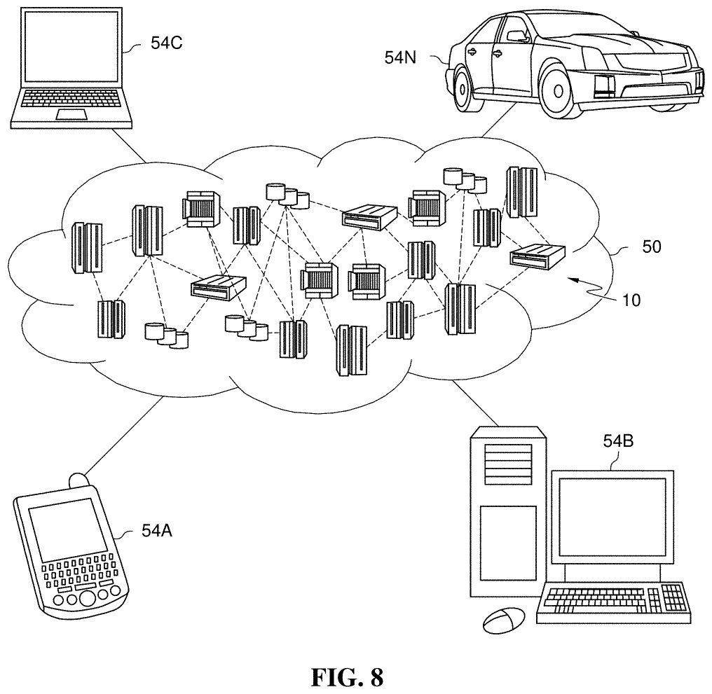

Referring now to FIG. 8, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A (e.g., user device 230), desktop computer 54B (e.g., devices 105, server 135, server 200, etc.), laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device.

It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

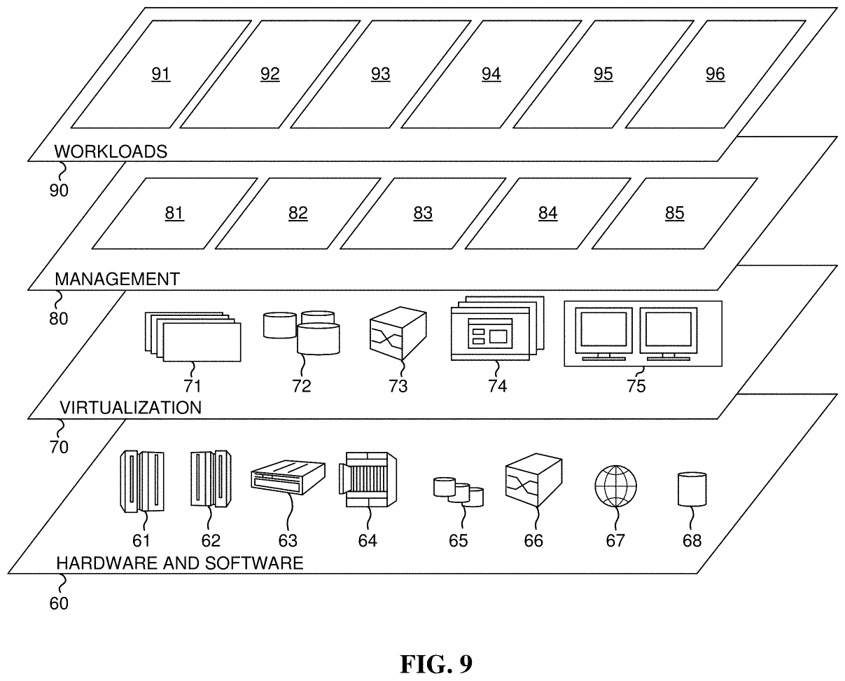

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and scheduling 96.

As discussed in more detail herein, it is contemplated that some or all of the operations of some of the embodiments of methods described herein can be performed in alternative orders or may not be performed at all; furthermore, multiple operations can occur at the same time or as an internal part of a larger process.

The present disclosure can be a system, a method, and/or a computer program product. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But, the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A computer-implemented method comprising:
receiving an indication of an attempt to schedule a first meeting designated at a first time;
receiving attendee calendar data for a prospective meeting attendee invited to the first meeting;
determining, by analyzing the attendee calendar data, that the prospective meeting attendee is scheduled with a second meeting designated at the first time;
calculating a probabilistic availability that the prospective meeting attendee will be available to attend the first meeting at the first time;
comparing the probabilistic availability to a threshold; and
scheduling, in response to the probabilistic availability satisfying the threshold, the first meeting at the first time for the prospective meeting attendee.

2. The method of claim 1, wherein the probabilistic availability is calculated based on a meeting attendance history associated with at least one criterion of the second meeting.

3. The method of claim 2, wherein the at least one criterion is a time slot.

4. The method of claim 2, wherein the at least one criterion is a meeting name.

5. The method of claim 2, wherein the at least one criterion is an attendee list.

6. The method of claim 2, wherein the meeting attendance history is calculated based on a number of attended meetings associated with the at least one criterion divided by a total number of meetings associated with the at least one criterion that the prospective meeting attendee was invited to.

7. The method of claim 6, wherein the number of attended meetings associated with the at least one criterion are determined by analyzing physical meeting tracking data.

8. A system comprising:
a memory storing program instructions; and
a processor configured to execute the program instructions to perform a method comprising:
receiving an indication of an attempt to schedule a first meeting designated at a first time;
receiving attendee calendar data for a prospective meeting attendee invited to the first meeting;
determining, by analyzing the attendee calendar data, that the prospective meeting attendee is scheduled with a second meeting designated at the first time;
calculating a probabilistic availability that the prospective meeting attendee will be available to attend the first meeting at the first time;
comparing the probabilistic availability to a threshold; and
scheduling, in response to the probabilistic availability satisfying the threshold, the first meeting at the first time for the prospective meeting attendee.

9. The system of claim 8, wherein the probabilistic availability is calculated based on a meeting attendance history associated with at least one criterion of the second meeting.

10. The system of claim 9, wherein the at least one criterion is a time of year.

11. The system of claim 9, wherein the at least one criterion includes a meeting name, attendee list, and time slot.

12. The system of claim 9, wherein the meeting attendance history is calculated based on a number of attended meetings associated the at least one criterion divided by a total number of meetings associated with the at least one criterion that the attendee was invited to.

13. The system of claim 12, wherein the number of attended meetings associated with the at least one criterion are determined by analyzing telephonic tracking data.

14. The system of claim 12, wherein the number of attended meetings associated with the at least one criterion are determined by analyzing web conference tracking data.

15. A computer program product comprising a computer readable storage medium having program instructions embodied therewith, wherein the computer readable storage medium is not a transitory signal per se, the program instructions executable by a processor to cause the processor to perform a method comprising:
receiving an indication of an attempt to schedule a first meeting designated at a first time;
receiving attendee calendar data for a prospective meeting attendee invited to the first meeting;
determining, by analyzing the attendee calendar data, that the prospective meeting attendee is scheduled with a second meeting designated at the first time;
calculating a probabilistic availability that the prospective meeting attendee will be available to attend the first meeting at the first time;
comparing the probabilistic availability to a threshold; and
scheduling, in response to the probabilistic availability satisfying the threshold, the first meeting at the first time for the prospective meeting attendee.

16. The computer program product of claim 15, wherein the probabilistic availability is calculated based on a meeting attendance history associated with at least one criterion of the second meeting.

17. The computer program product of claim 16, wherein the at least one criterion is a number within a meeting name.

18. The computer program product of claim 16, wherein the at least one criterion includes a meeting name, attendee list, and time slot.

19. The computer program product of claim 16, wherein the meeting attendance history is calculated based on a number of attended meetings associated with the at least one criterion divided by a total number of meetings associated with the at least one criterion that the attendee was invited to.

20. The computer program product of claim 19, wherein the number of attended meetings associated with the at least one criterion are determined by analyzing telephonic tracking data.
